(19) United States
(12) Patent Application Publication
(10) Pub. No.: US 2003/0159342 A1
(43) Pub. Date: Aug. 28, 2003

(54) Controlled ripening protective cover for agricultural products

(76) Inventors: Fermin Ruiz, San Luis Potosi (MX); Fernando Espinosa, San Luis Potosi (MX); Sergio Diaz De Leon, Clayton, NC (US); Nick Carter, Mooresville, NC (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 10/081,674

(22) Filed: Feb. 22, 2002

(51) Int. Cl. A01G 13/02

(52) U.S. Cl. 47/24.1

(57) ABSTRACT

A protective cover for protection of agricultural products comprises a fibrous nonwoven fabric exhibiting sufficient vapor permeability to alter or control the ripening of the agricultural product so ensconced while retarding passage of dust and insects. The protective cover is positioned generally about associated agricultural products, with the cover being particularly suited for use on products prior to harvest, such as bananas. The cover may be formed from fibrous and/or filamentary elements, and may be formed from fibrous material selected from the group consisting of thermoplastic polymers, thermoset polymers, natural fibers, and combinations thereof. The nonwoven fabric may be formed with protection-enhancing agents such as insecticidal, fungicidal, algaecidal, decay-inhibiting, and UV-protective agents. The nonwoven fabric may be pigmented as desired.

### TECHNICAL FIELD

The present invention relates generally to an arrangement for protecting agricultural products, including the protection of such products prior to harvesting, and more particularly to a protective cover for agricultural products formed from nonwoven fabric having the ability to both protect the agricultural product against dust and insects, and to alter or control the ripening of the agricultural product so ensconced, while permitting optional disposable use of the cover.

### BACKGROUND OF THE INVENTION

For many types of agricultural products, including food stocks such as bananas and pineapples, as well as non-food stocks such as briar, it is desirable to protect the products from dust and insects as the products mature and/or ripen in place on the associated vine or tree. In the past, tubular polyethylene films have been employed for protection of crops such as bananas, but experience has shown that these types of protective covers can be less than satisfactory due to adverse transmittance of light and transfer of moisture. In order to allow moisture to evaporate away from the agricultural products (which, in the case of bananas, can otherwise cause staining, and promote growth of fungi and the like), perforated polyethylene films have typically been used. However, the perforations can undesirably compromise the protection afforded by the covers, permitting ingress of dust and other contaminants.

The transmittance of light to an agricultural product is known to significantly affect the way that product develops and ripens. For example, bananas that are mass grown in plantations exhibit pronounced variations in the rate of ripening depending upon whether the banana plant is located within immediate proximity to a shade source, or are exposed to continuous daylight, such as along the periphery of the plantation.

Further, the ripening of agricultural products due to volatile ripening chemicals, whether endogenous or artificially supplied, is adversely affected when heretofore conventional plastic films have been employed as a protective means. This effect is particularly evident when one looks at food stocks such as bananas. When bananas are grown without any protective means, the natural ripening that occurs results in bananas on either end of the bunch that are either too ripe, or are excessively under-ripe, thus returning a lower value for the overall bunch. When conventional films are used as a protective means, the trapped volatile ripening chemicals, such a ethylene dioxide and gibberellins, are trapped and result in the overall bunch ripening too quickly and the bananas having a small size and low marketable weight.

PCT Publication No. WO98/51578 is directed to a bag-like cover for agricultural products, with the construction formed from cellulosic paper. However, the structure disclosed in this publication is not believed to exhibit the desired degree of durability when subjected to harsh or wet environments, and is not believed to provide the desired degree of gas permeability.

The present invention provides an improved form of protective cover for agricultural products which is particularly suited for use in controlling the in-situ ripening prior to harvest of the products, and which is configured for economical, and optionally, disposable use.

### SUMMARY OF THE INVENTION

A protective cover embodying the principles of the present invention is configured for protection of agricultural products, including products that have not yet been harvested, such as food stock exemplified by bananas and pineapples, as well as non-food stocks such as briar. The protective cover incorporates means for controlling the ripening of the agricultural product during growth so as to obtain optimum product value. The protective cover may either be in a sheet form that is secured about the entire or partial element of the agricultural product, or be constructed so as to have a tubular configuration sized to permit the cover to be positioned generally about an associated agricultural product, whereby the product is essentially enclosed.

The protective cover of the present invention comprises a fibrous nonwoven fabric formed from fibrous and/or filamentary elements, with the fibrous nonwoven fabric exhibiting the ability to regulate the ripening of the product, while retarding passage of dust and insects, thus protecting the agricultural products against potentially detrimental environmental conditions. Ripening of the agricultural product is controlled by way of the independent or combined application of varying levels of lights transmittance through regions of the protective cover with the degree and openness of apertures. Light transmittance can be controlled through such suitable means that reduce the level of light available to the agricultural product. Examples of controlled light transmittance are represented by the application of one or more of the following: printed regions having enhanced or reduced levels of reflectance; fibrous material having inclusion of reflectance modifying dyes, pigments, and/or opacifiers; changes in fibrous material density; and layering of one or more fibrous materials. In addition or alternative, open or occluded apertures may be included in regions of the overall protective cover so that the production or introduction of volatile ripening chemistries are vented, sequestered or otherwise transferred throughout the agricultural product.

The fibrous nonwoven fabric of the cover comprises fibrous material selected from the group consisting of thermoplastic polymers, thermoset polymers, natural fibers, and combinations thereof. The fibrous material of the nonwoven fabric can be heat-bonded, adhesive-bonded, or hydroentangled (spunlaced) to provide the fabric with the desired degree of integrity. The fibrous nonwoven fabric may be formed from filamentary elements, either independently or in conjunction with staple length fibers, by providing the fabric in the form of spunbond polymeric material.

The protective cover of the present invention can be provided with additional features to facilitate its effective use for protection of agricultural products. If desired, the nonwoven fabric may comprise one or more layers of secondary substrate, such as a porous polymeric film or reinforcing scrim, which may be integrated into the fabric by hydroentanglement, adhesive attachment, or other suitable consolidation means. Further, the fibrous nonwoven fabric may incorporate one or more protection enhancing agents selected from the group consisting of insecticidal, fungicidal, algaecidal, decay-inhibiting, volatile ripening chemistry absorbents and UV-protective, agents. Such protection-enhancing agents can be provided in the form of a melt-additive in the polymer, as a fiber surface treatment, and/or as a topical treatment applied to the nonwoven fabric. Additional pigmenting agents may also be employed.

A first method of protecting agricultural products in accordance with the present invention comprises the steps of providing at least one piece of nonwoven fabric formed from fibrous and/or filamentary elements, said piece of nonwoven fabric being circumferentially or partially applied to the agricultural product. The present method further includes cutting the nonwoven fabric to a selected length and width to form a protective cover for a desired agricultural product, and positioning the protective cover in proximity to the agricultural product to protect the product from dust and/or insects. The protective cover may be permanently, semi-permanently or temporarily affixed along one or more edges of the protective cover to the agricultural product by such representative means as adhesives and adhesive tapes, hook and loop fasteners, staples, zippers, snaps, buttons, and ties.

A second method of protecting agricultural products in accordance with the present invention comprises the steps of providing at least one piece of nonwoven fabric formed from fibrous and/or filamentary elements, and forming a tube from the nonwoven fabric by joining together edge portions thereof. The present method further includes cutting the tube to a selected length to form a protective cover, and positioning the protective cover generally about an agricultural product to protect the product from dust and/or insects. The nonwoven fabric may comprise heat-bonded polymeric staple length fibers, or adhesive-bonded fibrous material. When the fabric is formed from spunbond polymeric material, the fabric comprises substantially continuous polymeric filaments.

Further, with either of the aforementioned preferred embodiments, various means may be employed in the construction of the sheet and/or mode of connection so as to allow access through the protective cover and to the agricultural product beneath. The access means may be localized to one or more regions of the protective cover or extended essentially the length or width of the cover, and may include such representative practices as flaps, ports, and overlapped slits, with or without a further means for affixing the access means in a closed position.

Other features and advantages of the present invention will become readily apparent from the following detailed description, the accompanying drawings, and the appended claims.

### BRIEF DESCRIPTION OF THE DRAWINGS

FIG. 1 is a diagrammatic view of a forming apparatus for forming a nonwoven fabric for use as a protective cover for agricultural products in accordance with the principles of the present invention;

FIG. 2 is a diagrammatic view of a hydroentangling forming surface for formation of a nonwoven fabric for use in practicing the present invention;

FIG. 3 is a diagrammatic view of a forming surface for forming a nonwoven fabric for use in practicing the present invention;

FIGS. 3A-3D are diagrammatic views of a further forming surface for hydroentangling a nonwoven fabric for practice of the present invention;

FIG. 4 is a side view of a protective cover having been circumferentially applied to an agricultural product;

FIG. 5 is a side view of a representative protective cover having been modified across the upper region with a secondary layer of fibrous material so as to occlude light transmission;

FIG. 6 is a side view of a representative protective cover having been modified through the vertical median region with a continuous printed stripe so as to occlude light transmission; and

FIG. 7 is a side view of a representative protective cover having been modified through the horizontal median region with a continuous printed stripe so as to occlude light transmission.

### DETAILED DESCRIPTION

While the present invention is susceptible of embodiment in various forms, there is shown in the drawings, and will hereinafter be described, a presently preferred embodiment, with the understanding that the present disclosure is to be considered as an exemplification of the invention, and is not intended to limit the invention to the specific embodiment illustrated.

The present invention is directed to a protective cover for agricultural products, which is particularly suited for use on the products, such as for protection and controlled ripening of bananas and pineapples, prior to and during cultivation. During the growth of many agricultural products, it is desirable to protect the products from dust (which may include volcanic ash) and insects, while at the same time controlling the speed and uniformity at which the product develops and ripens.

The protective cover embodying the principles of the present invention is typically provided in either a sheet having a given width and length or in a generally tubular configuration sized to permit the cover to be positioned in immediate proximity to an associated agricultural product. The cover comprises a fibrous nonwoven fabric formed from fibrous and/or filamentary elements. The fibrous nonwoven fabric is selected to exhibit specifically controlled levels of light transmittance and/or control of volatile ripening chemistries such as the evolution of ethylene dioxide and gibberellins, while retarding passage of dust and ingress of insects.

The fibrous nonwoven fabric comprises fibrous material selected from the group consisting of thermoplastic polymers, thermoset polymers, natural fibers, and combinations thereof. The fibrous nonwoven fabric may be formed from filamentary elements when the fabric is provided in the form of a spunbond polymeric material. The nonwoven fabric preferably has a basis weight from about 10 to 100 gm/m², and in one especially preferred form, comprises polypropylene staple length fibers that are heat-bonded.

The present protective cover can be differently configured to facilitate its cost-effective use for protection of agricultural products. For some applications, it can be desired to incorporate at least one layer of secondary substrate, such as a reinforcing scrim or porous polymeric film, in the fabric, with formation of the fibrous nonwoven fabric by hydroentanglement (spunlacing) facilitating incorporation of such a scrim.

The fibrous nonwoven fabric may comprise polymeric material incorporating one or more protection-enhancing agents selected from the group consisting of insecticidal, fungicidal, algaecidal, decay-inhibiting, volatile ripening chemistry absorbents and UV-protective agents. It is also contemplated that the polymeric material of the fabric may comprise an overall pigmenting agent in conjunction with regions of alternate light transmittance. The protection-enhancing agents may be provided in the form of a melt-additive in the polymer from which the nonwoven fabric is formed, or may comprise a fiber surface treatment applied to the fibrous material from which the fabric is formed, prior to fabric formation. It is within the purview of the present invention that one or more of the protection-enhancing agents may comprise a topical treatment applied to the nonwoven fabric after it is formed.

In the following Examples, various techniques are described for formation of the nonwoven fabric from which the present protective cover is formed. At least one piece of nonwoven fabric is thereafter either used as a sheet, or formed into a tube by joining together edge portions thereof, with the tube cut to selected lengths to form the contemplated protective cover. The edge portions of the fabric may be joined during the tube-forming step by heat bonding, adhesive bonding, or sewing. The protective cover is positioned generally about or upon an associated agricultural product to protect the product from dust and/or insects.

### EXAMPLE 1

### Thermal Bonded Carded Staple Fiber

The present protective cover was formed from nonwoven fabric comprised of a conventional carded staple length polypropylene fiber of 9.0 denier by 2.0 inch staple length. The basis weight of the carded lap was 45 grams per square meter. The carded batt was thermally bonded by calender nip at a pressure of 450 pounds per linear inch, a calender anvil roll surface temperature of 300° F. to 310° F., a calender embossing roll surface temperature of 300° F. to 310° F., and a point pattern of 9% bond area relative to total surface area. The overall line speed for manufacturing the representative nonwoven fabric was approximately 400 feet per minute. The fabric was formed into a tube for formation of the present protective cover.

### EXAMPLE 2

### Spunbond Filamentary Elements

A bonded precursor web may be produced on a commercial spunbond production line using standard processing conditions. In particular, a polyester filament precursor web may be employed having a basis weight of 20 grams per square meter, and a filament denier of 1.8. The precursor web is bonded by calender at a calender temperature of 200 to 220° C., and a nip pressure of 320 PLI. The spunbond web was formed into a tube for formation of the present protective cover.

### EXAMPLE 3

### Non-Apertured Spunlace Fabric

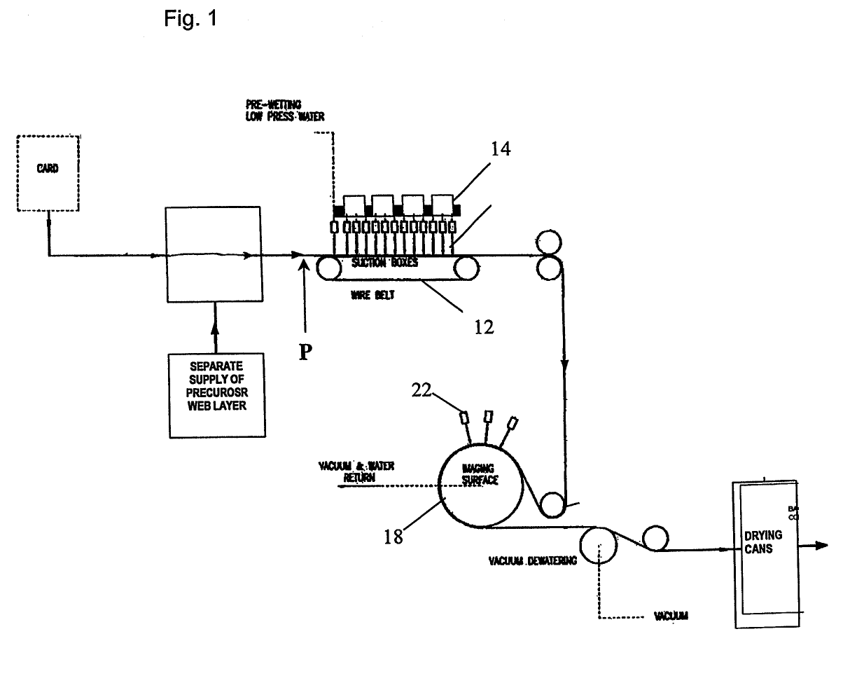

Using a forming apparatus as illustrated in FIG. 1, a nonwoven fabric was made in accordance with the present invention by providing a precursor web comprising 100 percent by weight polyester fibers as supplied by Wellman as Type T-472 PET, 1.2 dpf by 1.5 inch staple length. The precursor fibrous batt was entangled by a series of entangling manifolds such as diagrammatically illustrated in FIG. 1. FIG. 1 illustrates a hydroentangling apparatus for forming nonwoven fabrics in accordance with the present invention. The apparatus includes a foraminous-forming surface in the form of belt 12 upon which the precursor fibrous batt P is positioned for pre-entangling by entangling manifold 14 including a plurality of sub-manifolds. In the present examples, each of the sub-manifolds of the entangling manifolds 14 included three orifice strips including 120 micron orifices spaced at 42.3 per inch, with three of the sub-manifolds successively operated at 100, 300, and 600 pounds per square inch, with a line speed of 45 feet per minute. The precursor web was then dried using two stacks of steam drying cans at 300° F. The precursor web had a basis weight of 1.5 ounce per square yard (plus or minus 7%).

The precursor web the received a further 2.0 ounce per square yard air-laid layer of Type-472 PET fibrous batt. The precursor web with fibrous batt was further entangled by a series of entangling sub-manifolds, with the sub-manifolds successively operated at 100, 300, and 600 pounds per square inch, with a line speed of 45 feet per minute. The entangling apparatus of FIG. 1 further includes an imaging drum 18 comprising a three-dimensional image transfer device for effecting imaging of the now-entangled layered precursor web. The image transfer device includes a moveable imaging surface which moves relative to a plurality of entangling manifolds 22 which act in cooperation with three-dimensional elements defined by the imaging surface of the image transfer device to effect imaging and patterning of the fabric being formed. The entangling manifolds 22 included 120 micron orifices spaced at 42.3 per inch, with the manifolds operated at 2800 pounds per square inch each. The imaged nonwoven fabric was dried using two stacks of steam drying cans at 300° F.

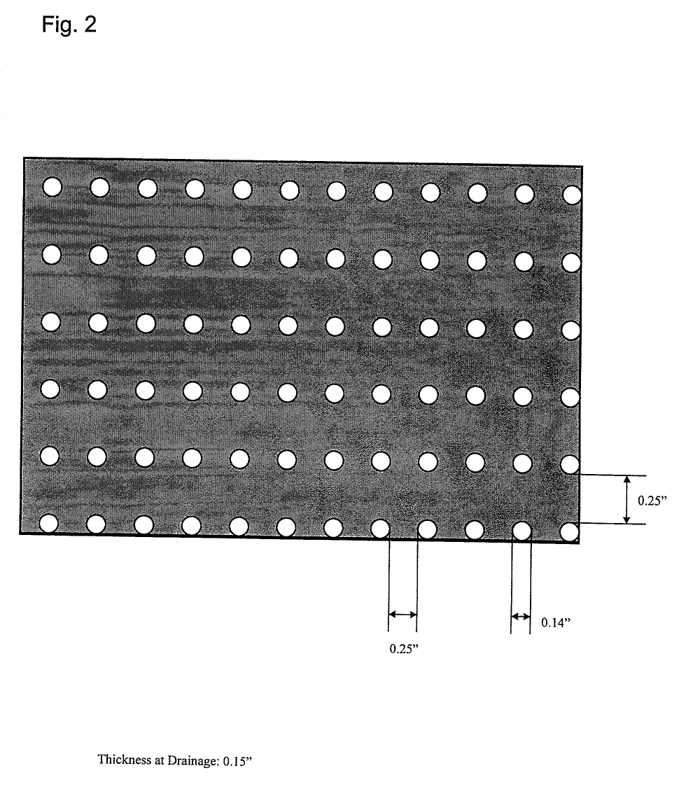

The three-dimensional image transfer device of drum 18 was configured with an image-forming surface consisting of non-aperturing inducing pattern, as illustrated in FIG. 2.

### EXAMPLE 4

### Apertured Spunlace

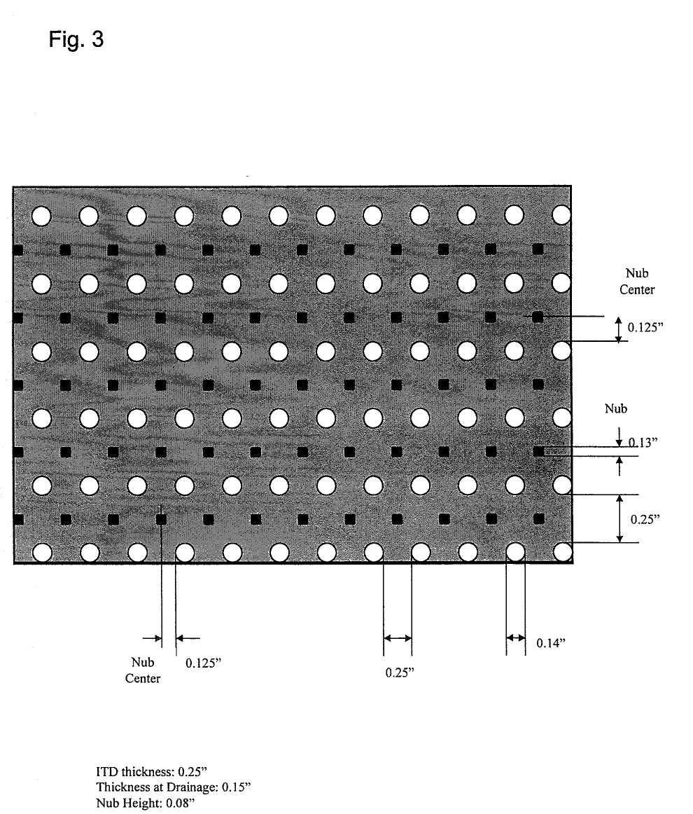

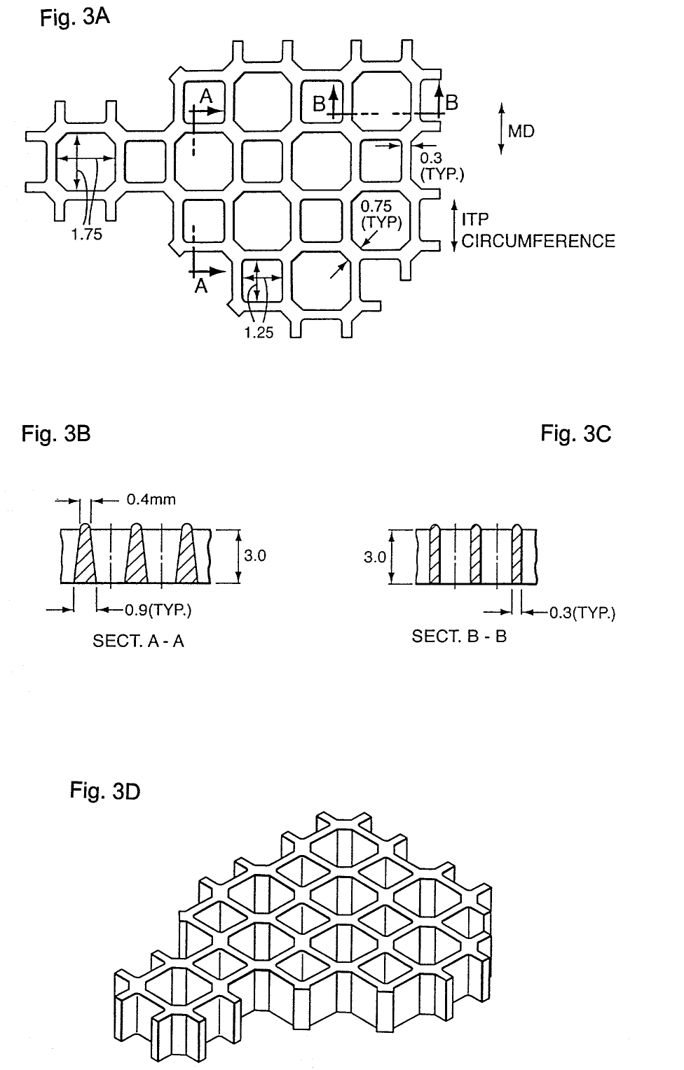

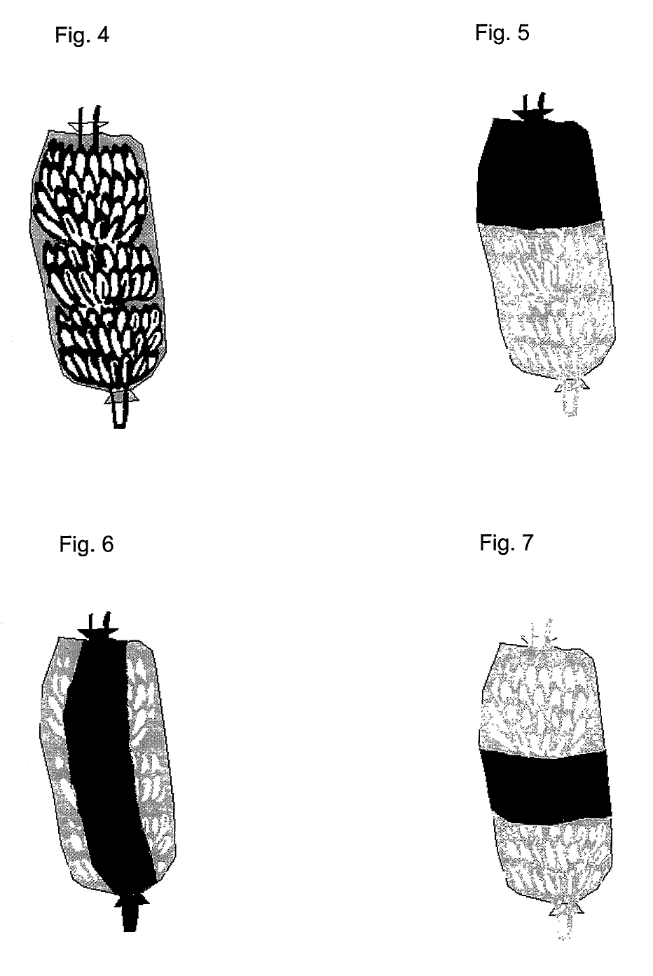

A fabric was fabricated by the process of the above example, whereby in the alternative, drum 18 was configured with an image forming surface consisting of an aperture inducing pattern, as illustrated in FIG. 3.

### EXAMPLE 5

### Non-Apertured Spunlace with Scrim

A composite nonwoven fabric was formed with the arrangement of FIG. 1, wherein the imaging device 18 had an “octagon/square” imaging surface such as is illustrated in FIGS. 3A-3D. The entangled layer was produced using 1.5 denier polyester staple fibers at 1.5 inch staple length, which were carded, cross-lapped and entangled using a Perfojet 2000 Jetlace entangler. The PET scrim layer 16 was a 7×5 mesh, 70 denier scrim available from Conwed Plastics of Minneapolis, Minn. A thermally bonded, 2.0 denier polyester thermally bonded fibrous layer was used as the bonded layer 20, with a 50 gsm target basis weight.

The fibrous layers were unwound at 40 feet per minute and impinged with three successive manifolds 22 each operating at 4000-psi pressure. Each manifold 22 had 120-micron diameter orifices spaced at 42.3 orifices per inch.

### EXAMPLE 6

### Spunbond with Film Extrusion

A base material was supplied in the form of a prewound roll of 85 gram per square meter (gsm) spunbond polypropylene having been previously hot calendered with a 14% land area pattern. To this base material a co-polyester film extrusion was applied by the use of a five-zone extruder system. The co-polyester polymer blend was comprised of an ethyl methyl acrylate at 65% (w/w) and a co-polyester polymer at 35% (w/w). The five-zone extruder was operated with each successive zone at 350° F., 450° F., 485° F., 525° F., and 515° F. The melt temperature of the molten film extrusion was 477° F. The cast station temperatures were 80° F. for the nip roll, 65° F. for the cast roll, and 70° F. for the stripper roll. The cast station roll pressures were 75 pounds per square inch for the nip roll and 60 pounds per square inch for the stripper roll. Overall line speed during the processing of this material was 51 feet per minute.

### EXAMPLE 7

### Mechanical Compaction of Nonwoven Fabric

Nonwoven fabrics may be further treated by mechanical compaction should the protective article require enhanced conformability.

Sanforizing

In order to enhance softness and drapeability of the present nonwoven fabric, the fabric may be subjected to slight mechanical compaction, such as by sanforizing (Sanforized® is a registered trademark of Cluett, Peabody & Co., Inc.). Such treatment has been found to enhance hand and drapeability of the fabric, without adversely affecting the mechanical characteristics of the fabric or being deleterious to the image imparted therein.

Micrexing

The nonwoven fabric used for the present invention can be subjected to mechanical compaction by a microcreping process. The particular microcreping process employed was that as is commercially available from the Micrex Corporation of Walpole, Mass., and is referred to by the registered mark of the same company as “MICREX”. The apparatus for performing MICREXING is described in U.S. Pat. No. 3,260,778, U.S. Pat No. 3,416,192, U.S. Pat No. 3,810,280, U.S. Pat No. 4,090,385, and U.S. Pat No. 4,717,329, hereby incorporated by reference. In such an apparatus, a means for imparting pressure applies a predetermined amount of pressure through a substructure, and extending across the path of a continuously supplied sheet of nonwoven fabric. The nonwoven fabric is carried by a rotating drive roll on which the pressure is imparted through the nonwoven fabric and against the rotating drive roll. While the nonwoven fabric is under applied pressure it then further impinges upon a retarding surface. This retarding surface in combination with the applied pressure induces the fabric into a creped form, with a resulting distortion of constituent fibrous components out of the planar aspect of the original nonwoven fabric.

So as to render the exemplary protective cover material described above capable of controlling the ripening of the agricultural product with which the protective cover is associated, one or more regions of the cover are modified or altered by inclusion of light-transmittance and/or volatile ripening chemistry control measures. Examples of suitable light transmittance control measures are represented by the application of one or more of the following: printed regions having enhanced or reduced levels of reflectance; fibrous material having inclusion of reflectance modifying dyes, pigments, and/or opacifiers; changes in fibrous material density; and layering of one or more fibrous materials. FIGS. 5 through 7 depict a protective cover in accordance with the present invention, having been applied to a representative agricultural food-stock. In FIG. 5, the upper aspect of the protective cover has been modified to have an impact on ripening of the agricultural product, hereby exemplified as an upper aspect having a lower level of light transmittance. This form of protective cover is particularly advantageous with the light source is in a top down presentation. FIGS. 6 and 7 represent alternate regions of altered ripening performance. Such modified aspects of are present in at least one region of the protective cover, and include changes in light transmission and/or variations in sequestering, venting, or transfer of volatile ripening agents.

From the foregoing, numerous modifications and variations can be effected without departing from the true spirit and scope of the novel concept of the present invention. It is to be understood that no limitation with respect to the specific embodiment disclosed herein is intended or should be inferred. The disclosure is intended to cover, by the appended claims, all such modifications as fall within the scope of the claims.

What is claimed is:

1. A protective cover for protection of agricultural products, said protective cover sized to permit said cover to be positioned generally about an associated agricultural product, said cover comprising a fibrous nonwoven fabric formed from fibrous and/or filamentary elements, said fibrous nonwoven fabric including a portion exhibiting the ability to modify the ripening of the agricultural product prior to harvesting, while retarding passage of dust and insects.

2. A protective cover for protection of agricultural products in accordance with claim 1, wherein:
said fibrous nonwoven fabric comprises fibrous material selected from the group consisting of thermoplastic polymers, thermoset polymers, natural fibers, and combinations thereof.

3. A protective cover for agricultural products in accordance with claim 1, wherein:
said fibrous nonwoven fabric has basis weight from about 10 to 100 gr/m².

4. A protective cover for agricultural products in accordance with claim 1, wherein:
said fibrous nonwoven fabric comprises polymeric staple length fibers.

5. A protective cover for agricultural products in accordance with claim 1, wherein:
said fibrous nonwoven fabric comprises spunbond polymeric material.

6. A protective cover for agricultural products in accordance with claim 1, wherein:
said cover comprises at least one piece of said fibrous nonwoven fabric, said piece of fibrous nonwoven fabric having at least one edge.

7. A protective cover for agricultural products in accordance with claim 1, wherein:
said piece of fibrous nonwoven fabric having at least one edge further comprises an affixing means selected from the group consisting of adhesives and adhesive tapes, hook and loop fasteners, staples, zippers, snaps, buttons, and ties.

8. A protective cover for agricultural products in accordance with claim 6, wherein:
said cover comprises at least one means for affixing the protective cover about an agricultural product.

9. A protective cover for agricultural products in accordance with claim 1, wherein:
said cover comprises at least one piece of said fibrous nonwoven fabric, with at least one seam joining edge portions of said piece of fabric, said seam being formed by at least one of heat-bonding, adhesive bonding, and sewing.

10. A protective cover for agricultural products in accordance with claim 1, wherein:
said fibrous nonwoven fabric further comprises a reinforcing scrim.

11. A protective cover for agricultural products in accordance with claim 1, wherein:
said cover further comprises a porous polymeric film layer.

12. A protective cover for agricultural products in accordance with claim 1, wherein:
said fibrous nonwoven fabric comprise polymeric material incorporating one or more protection-enhancing agents selected from the group consisting of insecticidal, fungicidal, algaecidal, decay-inhibiting, volatile ripening chemistry absorbent, UV-protective, and pigmenting agents.

13. A protective cover for agricultural products in accordance with claim 10, wherein:
said polymeric material is a thermoplastic polymer, and said protection enhancing agent is a melt-additive in said polymer.

14. A protective cover for agricultural products in accordance with claim 10, wherein:
said protection enhancing agent comprises a fiber surface treatment for said fibrous nonwoven fabric.

15. A protective cover for agricultural products in accordance with claim 10, wherein:
said protection enhancing agent comprises a topical treatment applied to said nonwoven fabric.

16. A protective cover for protection of agricultural products, said protective cover sized to permit said cover to be positioned generally about an associated agricultural product, said cover comprising a fibrous nonwoven fabric formed from fibrous and/or filamentary elements, said fibrous nonwoven fabric exhibiting the ability to modify the ripening of the agricultural product prior to harvesting while retarding passage of dust and insects, said modification of the ripening of the agricultural product occurring by alteration of the light transmittance in at least one region of the protective cover.

17. A protective cover for protection of agricultural products, said protective cover sized to permit said cover to be positioned generally about an associated agricultural product, said cover comprising a fibrous nonwoven fabric formed from fibrous and/or filamentary elements, said fibrous nonwoven fabric exhibiting the ability to modify the ripening of the agricultural product prior to harvesting while retarding passage of dust and insects, said modification of the ripening of the agricultural product occurring by alteration of the venting, sequestering, or transference of volatile ripening chemistries in at least one region of the protective cover.

18. A method of protecting agricultural products, comprising the steps of:
providing at least one piece of nonwoven fabric formed from fibrous and/or filamentary element;
forming a sheet from said nonwoven fabric having a finite length and width;
modifying at least one region of the nonwoven fabric so as to have an altered level of light transmittance; and
positioning said protective cover generally about an agricultural product to alter the ripening of the agricultural product prior to harvesting and protecting the product from dust and/or insects.

19. A method of protecting agricultural products in accordance with claim 18, wherein:
said nonwoven fabric comprises heat-bonded, polymeric staple length fibers.

20. A method of protecting agricultural products in accordance with claim 18, wherein:
said nonwoven fabric comprises hydroentangled staple length fibers.

21. A method of protecting agricultural products in accordance with claim 18, wherein:
said nonwoven fabric comprises adhesive-bonded fibrous material.

22. A method of protecting agricultural products in accordance with claim 18, wherein:
said nonwoven fabric comprises substantially continuous polymeric filaments.

23. A method of protecting agricultural products, comprising the steps of:
providing at least one piece of nonwoven fabric formed from fibrous and/or filamentary element;
modifying at least one region of the nonwoven fabric so as to have an altered level of light transmittance;
forming a tube from said nonwoven fabric by joining together of edge portions thereof;
cutting said tube to a selected length to form a protective cover; and
positioning said protective cover generally about an agricultural product to protect the product from dust and/or insects.

24. A method of protecting agricultural products in accordance with claim 14, wherein:
said tube-forming step includes joining edge portions of said piece of nonwoven fabric by at least one of heat bonding, adhesive bonding, and sewing.

25. A method of protecting agricultural products, comprising the steps of:
providing at least one piece of nonwoven fabric formed from fibrous and/or filamentary element;
forming a sheet from said nonwoven fabric having a finite length and width;
modifying at least one region of the nonwoven fabric so as to have an altered level of venting, sequestering, or transference of volatile ripening chemistries; and
positioning said protective cover generally about an agricultural product to alter the ripening of the agricultural product prior to harvesting and protecting the product from dust and/or insects.

26. A method of protecting agricultural products, comprising the steps of:
providing at least one piece of nonwoven fabric formed from fibrous and/or filamentary element;
modifying at least one region of the nonwoven fabric so as to have an altered level of venting, sequestering, or transference of volatile ripening chemistries;
forming a tube from said nonwoven fabric by joining together of edge portions thereof;
cutting said tube to a selected length to form a protective cover; and
positioning said protective cover generally about an agricultural product to protect the product from dust and/or insects.
